(19) United States
(12) Patent Application Publication
(10) Pub. No.: US 2025/0236005 A1
(43) Pub. Date: Jul. 24, 2025

(54) POWER TOOL WITH ELECTRO-MECHANICAL SPEED SELECT SWITCH

(71) Applicant: MILWAUKEE ELECTRIC TOOL CORPORATION, Brookfield, WI (US)

(72) Inventors: Michael LaValley, West Allis, WI (US); Matthew N. Lombardo, Muskego, WI (US); Sadaf Iqbal, Brookfield, WI (US); Zachary J. Jud, Milwaukee, WI (US); Brennan O'Gorman, West Bend, WI (US); Julia C. Marsh, Milwaukee, WI (US); Andrew D. van Hoorn, Menomonee Falls, WI (US)

(21) Appl. No.: 19/027,886

(22) Filed: Jan. 17, 2025

Related U.S. Application Data
(60) Provisional application No. 63/683,123, filed on Aug. 14, 2024.
(60) Provisional application No. 63/623,066, filed on Jan. 19, 2024.

(51) Int. Cl. B25F 5/00; B23B 45/00; B23B 45/02; B25F 5/02

(52) U.S. Cl. CPC B25F 5/001; B23B 45/008; B23B 45/02; B25F 5/026

(57) ABSTRACT

A power tool includes a housing, a motor supported within the housing, a transmission operatively coupled to the motor, the transmission shiftable between a low speed high torque mode and a high speed low torque mode, a spindle configured to receive torque from the motor through the transmission, a speed selector including an actuator movable to shift the transmission between the low speed high torque mode and the high speed low torque mode, a shaft movable in response to movement of the actuator, a magnet coupled to the shaft, and a controller configured to vary an operating speed of the motor based on a detected position of the magnet.

### CROSS-REFERENCE TO RELATED APPLICATIONS

This application claims priority to U.S. Provisional Patent Application No. 63/683,123, filed Aug. 14, 2024, and U.S. Provisional Patent Application No. 63/623,066, filed Jan. 19, 2024, the entire contents of both of which are incorporated herein by reference.

### FIELD OF THE DISCLOSURE

The present disclosure relates to a power tool, and more particularly, a core drill.

### BACKGROUND OF THE DISCLOSURE

Core drills are typically used to remove a cylinder of material from a workpiece.

### SUMMARY OF THE DISCLOSURE

In some aspects, the techniques described herein relate to a power tool including: a housing; a motor supported within the housing; a transmission operatively coupled to the motor, the transmission shiftable between a low speed high torque mode and a high speed low torque mode; a spindle configured to receive torque from the motor through the transmission; a speed selector including an actuator movable to shift the transmission between the low speed high torque mode and the high speed low torque mode, a shaft movable in response to movement of the actuator, and a magnet coupled to the shaft; and a controller configured to vary an operating speed of the motor based on a detected position of the magnet.

In some aspects, the techniques described herein relate to a power tool including: a housing; a motor supported within the housing; a gear housing supported within the housing; a transmission disposed within the gear housing and operatively coupled to the motor, the transmission shiftable between a low speed high torque mode and a high speed low torque mode; a spindle configured to receive torque from the motor through the transmission; an actuator movable to shift the transmission between the low speed high torque mode and the high speed low torque mode; a cam coupled to and movable with the actuator; a shaft configured to be axially displaced by movement of the cam; and a controller configured to vary an operating speed of the motor in response to displacement of the shaft, wherein the cam and the shaft are disposed between the housing and the gear housing.

In some aspects, the techniques described herein relate to a power tool including: a housing; a motor supported within the housing; a transmission operatively coupled to the motor, the transmission including a first gear, a second gear, and a shift collar configured to engage the first gear or the second gear; a spindle configured to receive torque from the motor through the transmission; an actuator rotatable to move the shift collar to engage the first gear or the second gear; a shaft configured to be axially displaced by rotation of the actuator; and a sensing assembly configured to detect a position of a magnet supported by the shaft to electronically change an operating speed of the motor.

Other features and aspects of the present disclosure will become apparent upon consideration of the following detailed description and accompanying drawings.

### BRIEF DESCRIPTION OF DRAWINGS

FIG. 1 is a perspective view of a core drill in accordance with an embodiment of the disclosure, a tool bit is coupled to the core drill.

FIG. 2 is another perspective view of the core drill of FIG. 1 without the tool bit.

FIG. 3 is a cross-sectional view of the core drill of FIG. 1, taken along line 3-3 in FIG. 1.

FIG. 4 is a top view of the core drill of FIG. 1 including an electro-mechanical speed switch in accordance with an embodiment of the disclosure, the electro-mechanical speed switch disposed in a first position.

FIG. 5 is an enlarged side view of the core drill of FIG. 1, the electro-mechanical speed switch of FIG. 4 including an actuator knob in the first position.

FIG. 6 is a cross-sectional view of the electro-mechanical speed switch of FIG. 4 with portions removed.

FIG. 7 is an enlarged side view of the core drill of FIG. 1, the actuator knob of FIG. 5 disposed in a second position.

FIG. 8 is a top view of the core drill of FIG. 1, the electro-mechanical speed switch of FIG. 4 in the second position.

FIG. 9 is a cross-sectional view of the electro-mechanical speed switch of FIG. 8 with portions removed.

FIG. 10 is an enlarged side view of the core drill of FIG. 1, the actuator knob of FIG. 5 disposed in a third position.

FIG. 11 is a top view of the core drill of FIG. 1, the electro-mechanical speed switch of FIG. 4 in the third position.

FIG. 12 is a cross-sectional view of the electro-mechanical speed switch of FIG. 11 with portions removed.

FIG. 13 is an enlarged view of the core drill of FIG. 1, the actuator knob of FIG. 5 disposed in a fourth position.

FIG. 14 is a top view of the core drill of FIG. 1, the electro-mechanical speed switch of FIG. 4 in the fourth position.

FIG. 15 is a cross-sectional view of the electro-mechanical speed switch of FIG. 14 with portions removed.

FIG. 16 is a cross-sectional view of an electro-mechanical speed switch in accordance with another embodiment of the disclosure.

FIG. 17 is a graph illustrating changes in magnetic flux at various linear travel distances of a shaft of the electro-mechanical speed switch of FIG. 4.

FIG. 18 is a graphic illustration of magnetic flux of a magnet of the electro-mechanical speed switch of FIG. 4.

FIG. 19 is a perspective view of a core drill with portions removed, the core drill including an electro-mechanical speed switch in accordance with another embodiment of the disclosure.

FIG. 20 is a top view of the core drill of FIG. 20.

FIG. 21 is an enlarged perspective view of the core drill of FIG. 20.

FIG. 22 is an enlarged top perspective view of the core drill of FIG. 20.

FIG. 23 is an enlarged side view of the core drill of FIG. 20.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

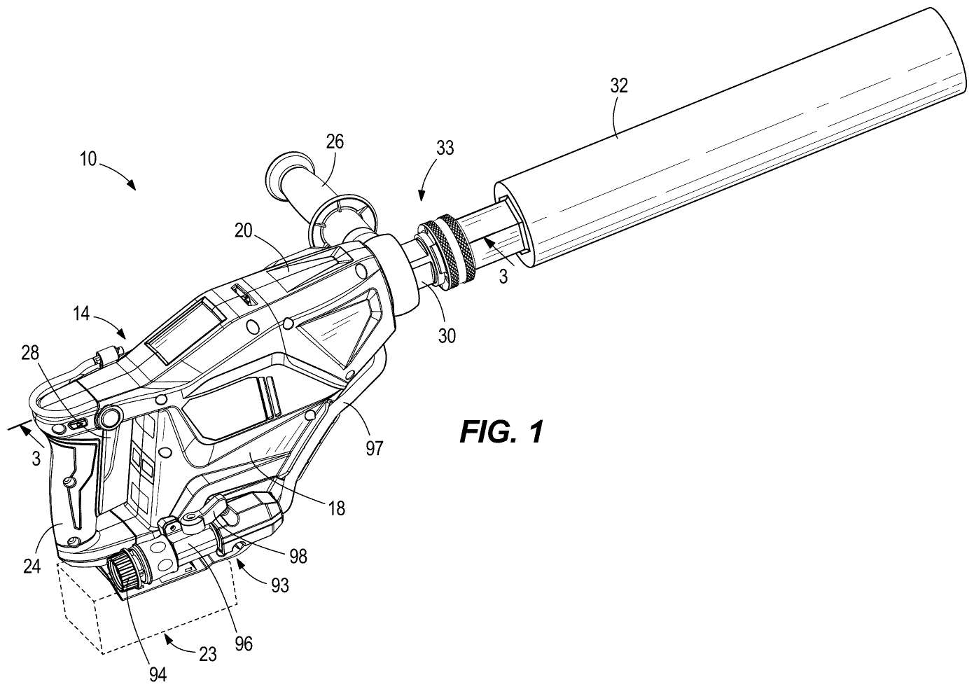

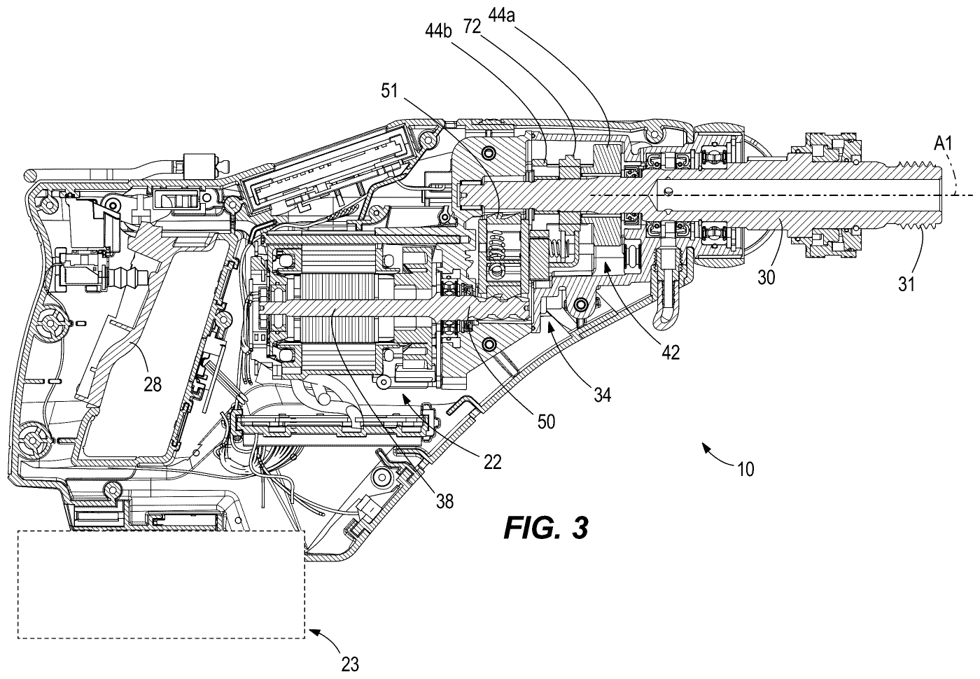

FIG. 1 illustrates a power tool in the form of a core drill 10. The core drill 10 includes a housing 14 having a motor housing portion 18 and a drive housing portion 20. A motor 22 (FIG. 3) is disposed within the motor housing portion 18 of the housing 14 and is a brushless direct current motor in the illustrated embodiment. In other embodiments, the core drill 10 may include other types of motors. The illustrated core drill 10 is cordless and includes a battery 23 that provides power to the motor 22. In other embodiments, the core drill 10 may be a corded tool configured to receive power from a wall outlet or other remote power source.

The core drill 10 further includes a primary handle or a first handle 24 and an auxiliary handle or a second handle 26. The first handle 24 is coupled to the motor housing portion 18 and disposed rearward of the motor housing portion 18. The first handle 24 is configured to be grasped by a user during operation of the core drill 10. The second handle 26 is removably coupled to the drive housing portion 20. A trigger 28 is provided on the first handle 24 and energizes the motor 22 when depressed by a user. The trigger 28 may be, for example, a variable-speed trigger operable to vary an operating speed of the motor 22 based on an extent to which the trigger 28 is pulled. In other embodiments, the trigger 28 may be an on/off trigger operable to energize the motor 22 to a preset speed. In either case, the trigger 28 has an initial position, in which the motor 22 is de-energized, and a fully-actuated position, in which the motor 22 is operable at a maximum rotational speed for a particular operational setting of the core drill 10, as described in greater detail below.

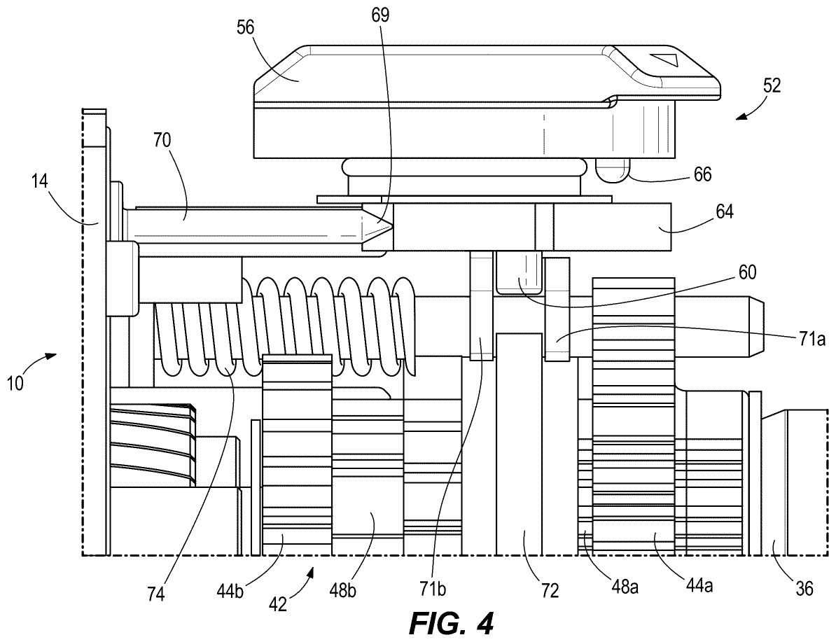

With reference to FIGS. 3 and 4, the core drill 10 includes a spindle 30 rotatable about a rotational axis A1 in response to receiving torque from the motor 22. A tool bit 32 (e.g., a core drilling bit; FIG. 1) can be coupled to a threaded end 31 of the spindle 30 for co-rotation with the spindle 30 to perform work (e.g., core drilling) on a workpiece. In the illustrated embodiment, a locking collar 33 is provided to allow a user to apply a pre-load to the threaded connection between the spindle 30 and the tool bit 32 to secure the tool bit 32. The locking collar 33 may also be actuated to release the pre-load to facilitate removal of the tool bit 32.

A drive assembly 34 is disposed within the drive housing portion 20 of the housing 14 and is configured to transmit torque from an output shaft 38 of the motor 22 to the spindle 30. The illustrated drive assembly 34 includes a multi-speed transmission 42 having a first gear or low gear 44a with a first splined portion 48a and a second gear or high gear 44b with a second splined portion 48b. The low gear 44a and the high gear 44b are sleeved around a rear end portion of the spindle 30 (opposite the threaded end 31 of the spindle 30) and are rotatable relative to the spindle 30. The low gear 44a and the high gear 44b are meshed with and continuously driven by respective first and second driving gears (not shown). The first and second driving gears are fixed to an intermediate shaft (not shown). A pinion 50, which is integrally formed on the output shaft 38 in the illustrated embodiment, meshes with an intermediate gear 51 (e.g., a helical gear) coupled to the intermediate shaft (not shown) for co-rotation (FIG. 3). The intermediate gear 51 may be coupled to intermediate shaft in any number of different ways (e.g., a key and keyway arrangement, an interference fit, a spline-fit, etc.). In some embodiments, the intermediate gear 51 may be coupled to the intermediate shaft via a clutch mechanism.

A shift collar 72 is coupled for co-rotation with the spindle 30 and positioned between the low gear 44a and the high gear 44b. As described in greater detail below, the shift collar 72 is movable along the axis A1 to selectively engage the low gear 44a or the high gear 44b and thereby couple the selected gear 44a, 44b for co-rotation with the spindle 30. In this way, the shift collar 72 selects which of the gears 44a, 44b drives the spindle 30. The low gear 44a has a relatively greater number of teeth than the high gear 44b. Thus, in the illustrated embodiment, the shift collar 72 is shiftable to a first position, in which the shift collar 72 engages the low gear 44a to define a low speed-high torque mode of the drive assembly 34. The low speed-high torque mode provides a first gear ratio between the output shaft 38 and the spindle 30. The shift collar 72 is shiftable to a second position, in which the shift collar 72 engages the high gear 44b to define a high speed-low torque mode of the drive assembly 34. The high speed-low torque mode provides a second gear ratio between the output shaft 38 and the spindle 30 that is less than the first gear ratio. In some embodiments, the first gear ratio may be between 10:1 and 20:1, and the second gear ratio may be between 3:1 and 8:1. In some embodiments, the first gear ratio may be between 12:1 and 18:1. In some embodiments, the first gear ratio may be between 14:1 and 17:1. In some embodiments, the second gear ratio may be between 4:1 and 7:1. In some embodiments, the second gear ratio may be between 5:1 and 6:1. In some embodiments, the first gear ratio may be at least 2× the second gear ratio. In some embodiments, the first gear ratio may be at least 2.5× the second gear ratio. In some embodiments, the first gear ratio may be at least 3× the second gear ratio. In some embodiments, the transmission 42 may be configured to be shifted between more than two gear ratios.

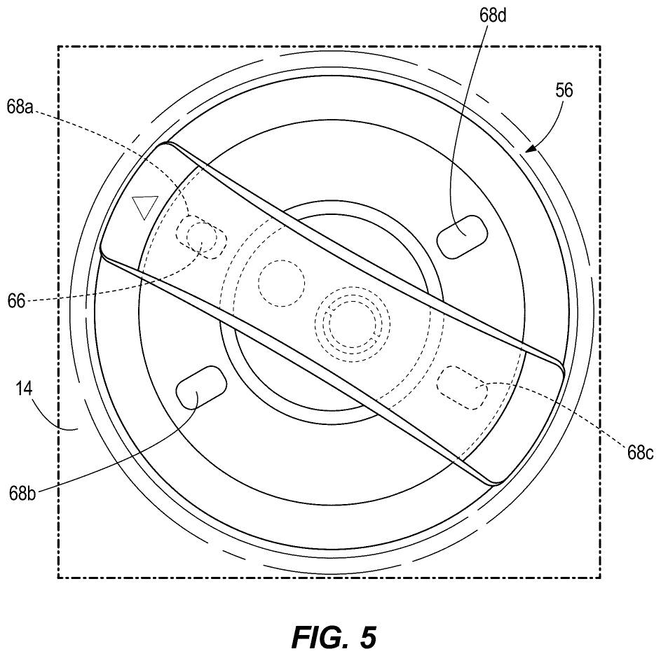

The core drill 10 also includes a speed selector or electro-mechanical speed switch 52 having an actuator knob 56, a rod 60 coupled to and extending from the actuator knob 56, and a cam plate 64 also coupled to the actuator knob 56. The actuator knob 56 is disposed along the drive housing portion 20 and configured to be rotated by a user to adjust an output speed at which the spindle 30 rotates. As the actuator knob 56 is rotated, a spring biased pin 66 interacts with one of four detent pockets 68a-d (FIG. 5) defined in the housing 14 of the core drill 10. The detent pockets 68a-d define four different output speeds at which the core drill 10 may be operated at.

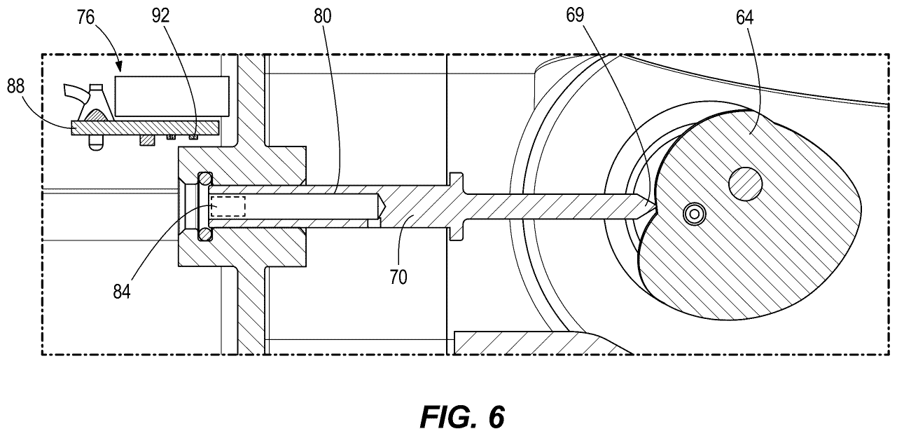

FIG. 6 illustrates a shaft 70 and a sensing assembly 76 disposed within the housing 14 of the core drill 10. The shaft 70 is formed with a pin-like or tapered end 69 that cooperates with the cam plate 64 to permit axial displacement of the shaft 70 within the housing 14. A pocket 80 is defined within the shaft 70 and is configured support and retain a magnet 84. The sensing assembly 76 includes a hall sensor board 88 and a Hall Effect sensor 92 disposed on the hall sensor board 88. In other embodiments, the Hall Effect sensor 92 may be remote and wired to another separate printed circuit board (PCB). The Hall Effect sensor 92 is configured to detect a position of the magnet 84 as the shaft 70 moves within the housing 14. The sensing assembly 76 also includes a ferrous metal part 78 disposed along the hall sensor board 88 to cause the magnetic flux of the magnet 84 to be denser at a top side of the magnet 84.

When rotating the actuator knob 56, the rod 60 is configured to move the shift collar 72 of the transmission 42 to adjust a gear ratio of the transmission 42. Specifically, the rod 60 pushes first plate 71a in a right direction to thereby energize a spring 74 against second plate 71b. When the shift collar 72 is properly aligned with the low gear 44a, then the shift collar 72 will move onto the first splined portion 48a to engage the low gear 44a. When the shift collar 72 is not aligned, then the stored energy of the spring 74 energizes the second plate 71b and the shift collar 72. The second plate 71b and shift collar 72 will then move when the low gear 44a is moved into alignment with the shift collar 72. As such, a user may set a desired position of the actuator knob 56 without manipulating the spindle 30.

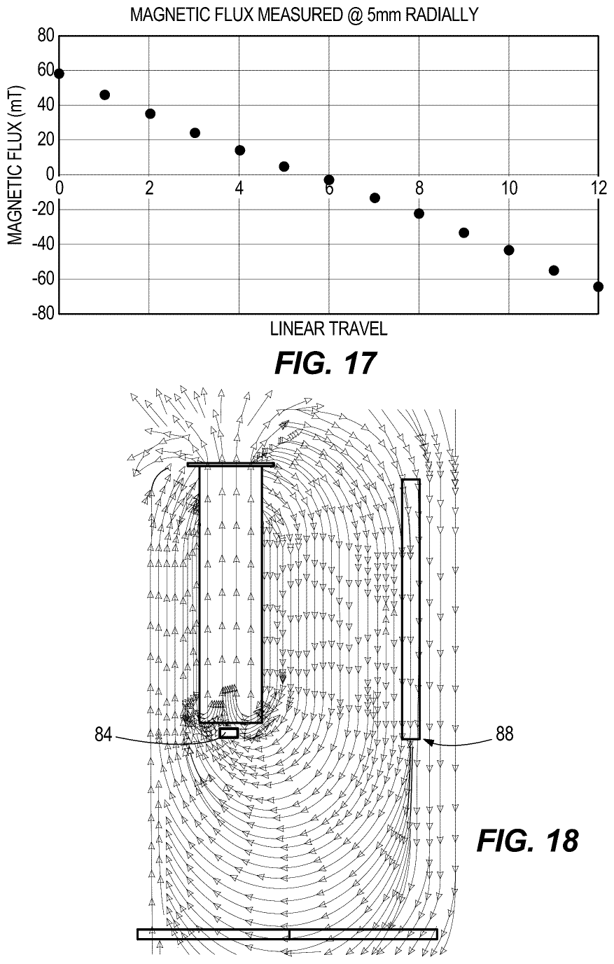

The cam plate 64 is configured to co-rotate with the actuator knob 56 such that the shaft 70 is displaced to permit movement of the magnet 84. Movement of the magnet 84 adjusts an output of the Hall Effect sensor 92 to deliver different current levels to the motor 22 to electronically change speed of the motor 22 without needing to change the gear ratio of the transmission 42. The magnetic flux produced by the magnet 84 and detected by the Hall Effect sensor 92 is illustrated in FIG. 18, and FIG. 17 illustrates that the magnetic flux detected by the Hall Effect sensor 92 varies based on displacement of the shaft 70 and magnet 84.

In operation, when the actuator knob 56 is disposed in a first position (FIGS. 4-6), the shift collar 72 is moved to engage the low gear 44a thereby placing the drive assembly 34 in the low speed-high torque mode. The magnet 84 is disposed at a first right position, such that the Hall Effect sensor 92 reads a positive magnetic field and a controller (which may be implemented, for example, as a microprocessor, machine-readable, non-transitory memory, and switching electronics, such as FETs, for controlling the delivery of power to the motor 22) controls the motor 22 to operate at a first motor speed (e.g., 16,000 RPM-17,000 RPM in some embodiments) when the trigger 28 is fully depressed. Thus, the first position of the actuator knob 56 defines a first speed setting of the core drill 10. In some embodiments, the spindle 30 may rotate at a maximum speed between 800 RPM and 1,200 RPM, between 900 RPM and 1,100 RPM, or about 1,000 RPM when the core drill 10 is in the first speed setting.

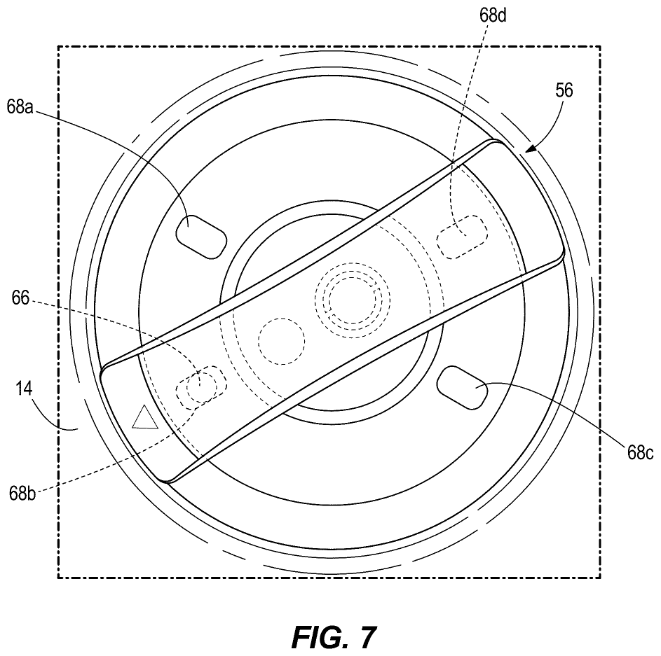

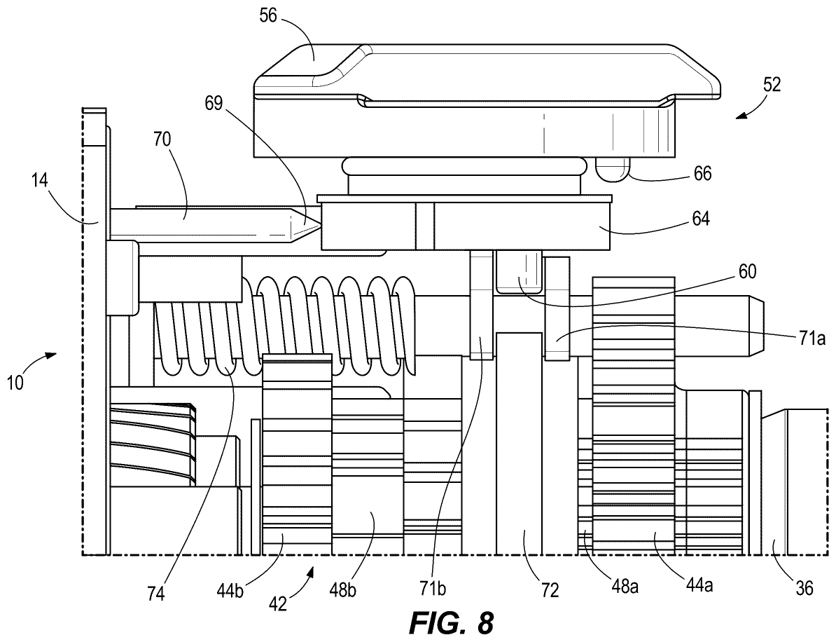

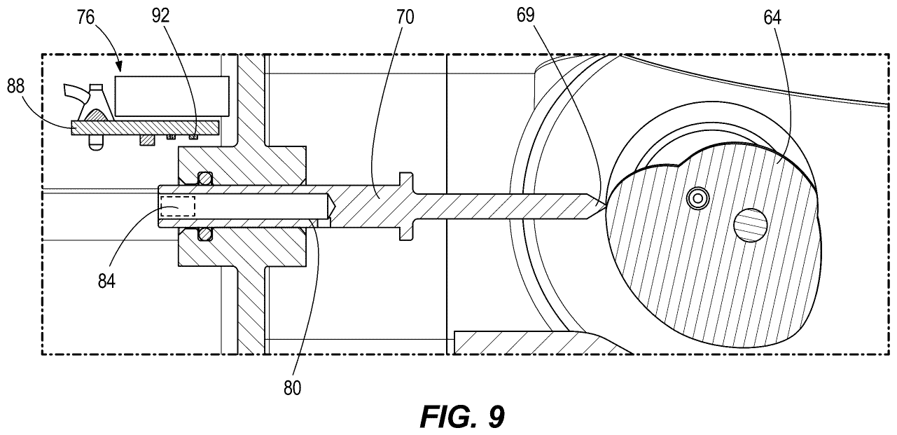

To increase the speed of the spindle 30, the actuator knob 56 can be rotated (e.g., counterclockwise) to be disposed in a second position (FIGS. 7-9). In the second position, the shift collar 72 remains engaged to the low gear 44a such that no change is made to the gear ratio of the transmission 42. As the cam plate 64 rotates with the actuator knob 56, the shaft 70 is displaced such that the magnet 84 moves in a first direction or a left direction. The Hall Effect sensor 92 reads a neutral magnet field and communicates with the controller to electronically change the speed of the motor 22 from the first speed to a second motor speed (e.g., 26,000-27,000 RPM) that is greater than the first speed when the trigger 28 is fully depressed. Thus, the second position of the actuator knob 56 defines a second speed setting of the core drill 10. In some embodiments, the spindle 30 may rotate at a maximum speed between 1,400 RPM and 1,800 RPM, between 1,500 RPM and 1,700 RPM, or about 1,600 RPM when the core drill 10 is in the second speed setting.

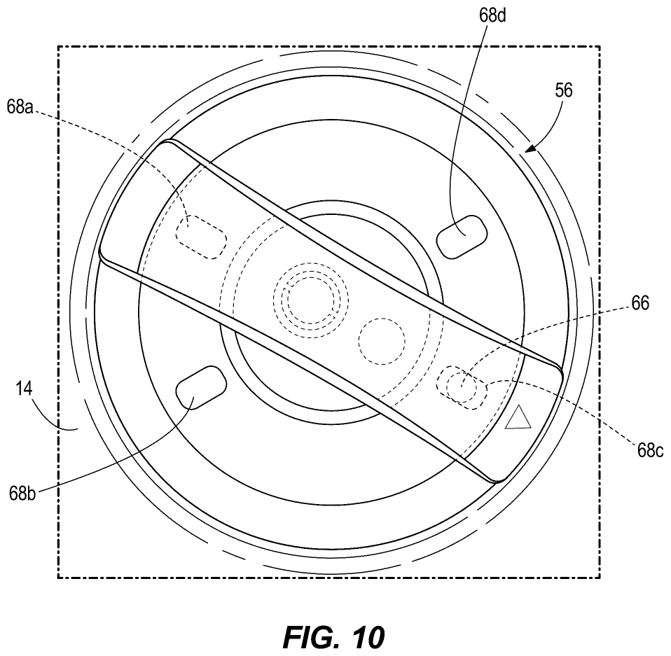

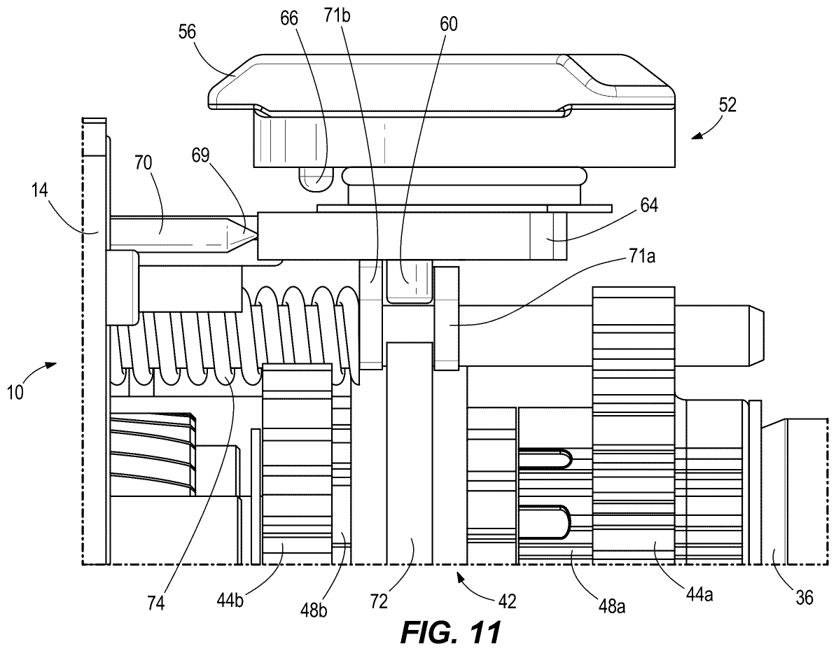

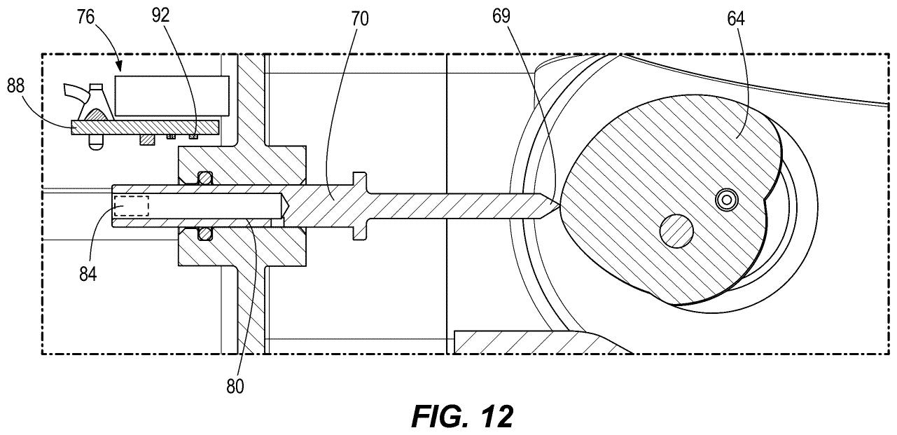

When the actuator knob 56 is further rotated counterclockwise to be in a third position (FIGS. 10-12), the shift collar 72 is moved to engage the high gear 44b and change the gear ratio of the transmission 42 to the high speed-low torque mode. The shaft 70 is displaced such that the magnet 84 moves further in the left direction. The Hall Effect sensor 92 reads a negative magnetic field and the motor 22 is operated by the controller at a third motor speed (e.g., 14,500 RPM-15,500 RPM) when the trigger 28 is fully depressed. Thus, the third position of the actuator knob 56 defines a third speed setting of the core drill 10. In some embodiments, the third motor speed is less than both the first motor speed and the second motor speed. In some embodiments, the third motor speed may be equal to the first motor speed. In some embodiments, the third motor speed may be greater than the first motor speed and less than the second motor speed. In some embodiments, the spindle 30 may rotate at a maximum speed between 2,300 RPM and 2,900 RPM, between 2,500 RPM and 2,700 RPM, or about 2,600 RPM when the core drill 10 is in the third speed setting.

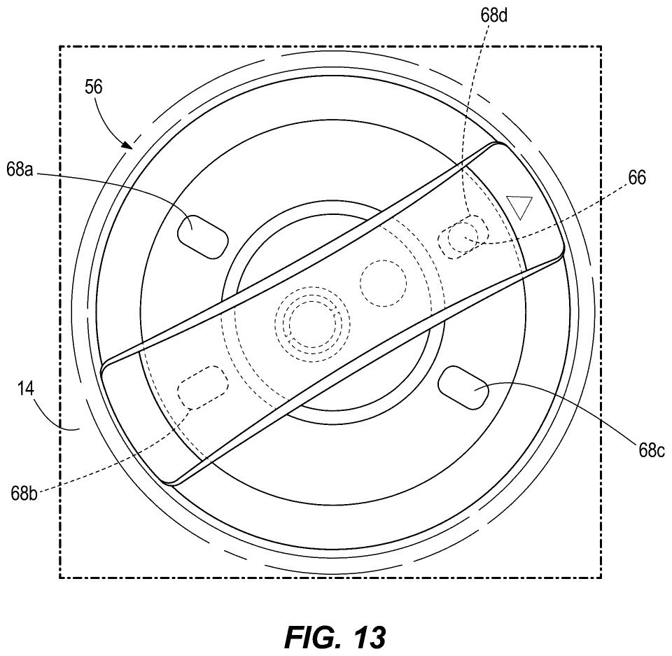

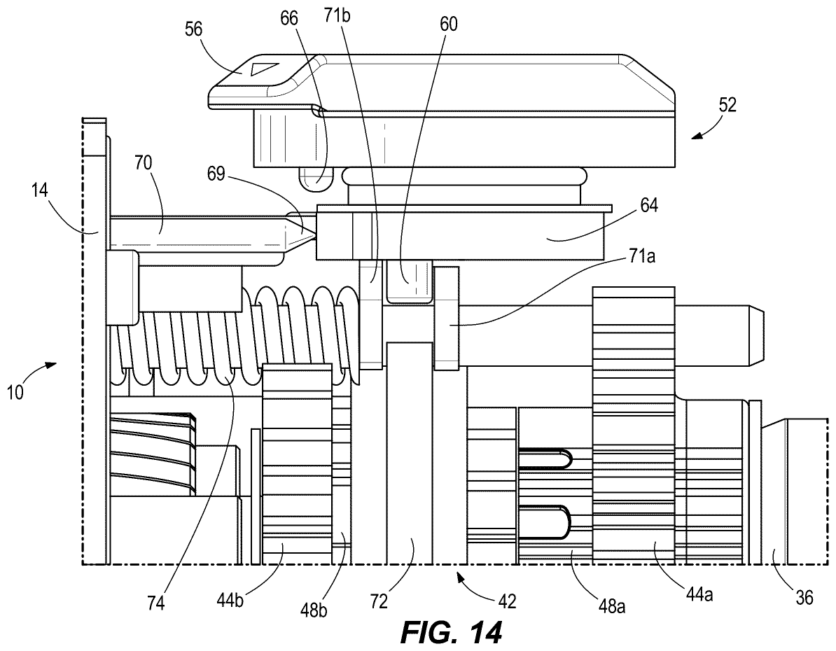

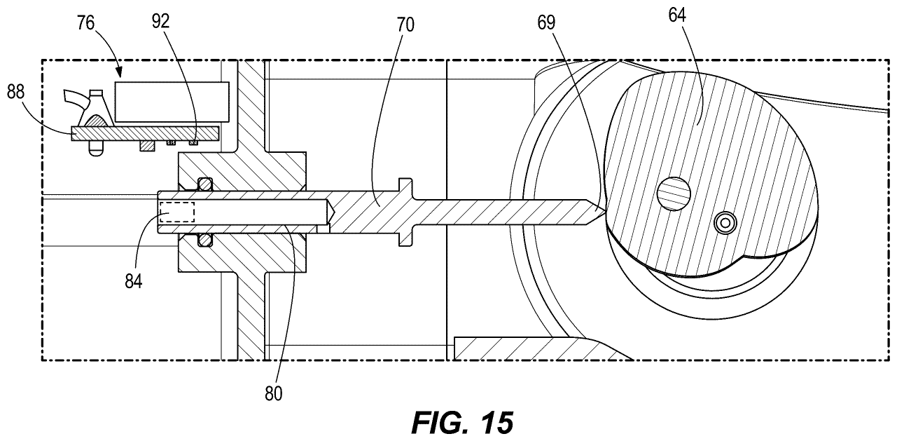

When the actuator knob 56 is further rotated to be in a fourth position (FIGS. 13-15), the shift collar 72 remains engaged to the high gear 44b such that no change is made to the gear ratio of the transmission 42. Again, the shaft 70 is displaced by the rotation of the cam plate 64 such that the magnet 84 moves in a second direction or a right direction. The Hall Effect sensor 92 reads a neutral magnetic field and the motor 22 is operated by the controller at a fourth motor speed (e.g., 26,000 RPM-27,000 RPM) when the trigger 28 is fully depressed. Thus, the fourth position of the actuator knob 56 defines a fourth speed setting of the core drill 10. In some embodiments, the fourth motor speed is greater than both the first motor speed and the third motor speed. In some embodiments, the fourth motor speed may be equal to the second motor speed. In some embodiments, the fourth motor speed may be greater than or less than the second motor speed. In some embodiments, the spindle 30 may rotate at a maximum speed between 3,500 RPM and 5,500 RPM, between 4,000 RPM and 5,000 RPM, or about 4,570 RPM when the core drill 10 is in the fourth speed setting.

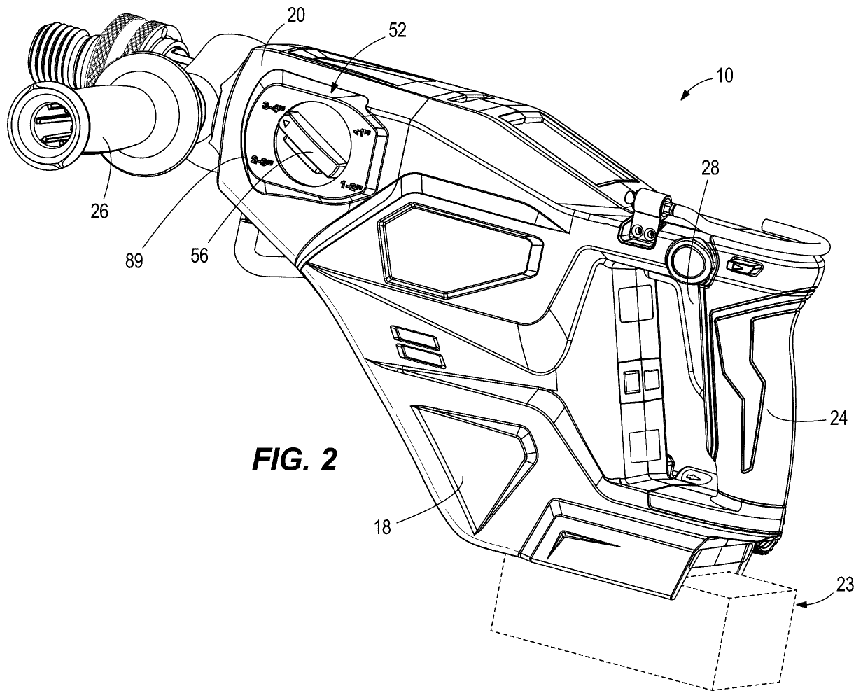

The first, second, third, and fourth speed settings described above have been found to provide optimum performance with differently sized core drilling bits 32. Referring to FIG. 2, the illustrated core drill 10 includes indicia 89 surrounding the actuator knob 56 at positions corresponding with the four respective speed settings. The indicia 89 illustrate a nominal size or size range of various core drilling bits 32 that may be attached to the spindle 30. In some embodiments, the indicia 89 may indicate that the first position of the actuator knob 56 and first speed setting corresponds with core drilling bits 32 having a diameter between 3-4 inches, the second position of the actuator knob 56 and second speed setting corresponds with core drilling bits 32 having a diameter between 2-3 inches, the third position of the actuator knob 56 and third speed setting corresponds with core drilling bits 32 having a diameter between 1-2 inches, and the fourth position of the actuator knob 56 and fourth speed setting corresponds with core drilling bits 32 having a diameter of less than 1 inch. In this way, electro-mechanical speed switch 52 provides the core drill 10 with four easily-accessible speed settings optimized for different bit sizes while only requiring two mechanical gear positions. The electro-mechanical speed switch 52, as described above, can be incorporated into other types of power tools, however.

With reference back to FIG. 1, the core drill 10 includes a fluid distribution system 93. The fluid distribution system 93 has a first connector 94, a second connector 95 coupled to the motor housing portion 18, and a control valve 96 also coupled to the motor housing portion 18. The first connector 94 is attachable to a supply line (not shown) to provide fluid (e.g., water) to the fluid distribution system 93 from an external source (not shown). A delivery line 97 extends from the second connector 95 and into the drive housing portion 20 to be connected to a third connector 98 (FIG. 3) of the fluid distribution system 93. The control valve 96 is disposed between the first and second connectors 94, 95 to regulate fluid flow from the supply line to the delivery line 97. The control valve 96 has a handle 99 movable between a first position and a second position by the user. In the first position, the control valve 96 is in an off state in which fluid flow from the first connector 94 to the second connector 95 is prohibited. In the second position, the control valve 96 is in an on state in which fluid flow from the first connector 94 to the second connector 95 is permitted. As such, during the on state, fluid is permitted to flow through the delivery line 97 and to the spindle 30 for cooling, lubrication, and dust abatement of the tool bit 32.

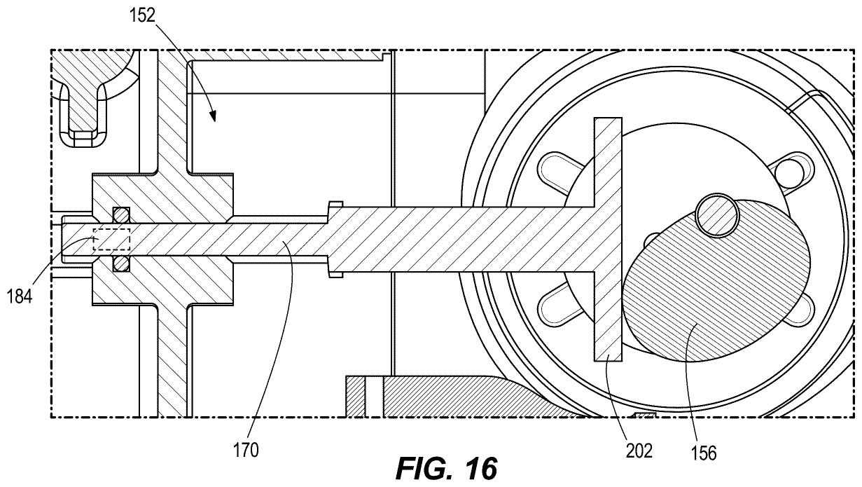

FIG. 16 illustrates another electro-mechanical speed switch 152 that can be incorporated into the core drill 10 of FIG. 1. The electro-mechanical speed switch 152 may also be incorporated into other types of power tools. The electro-mechanical speed switch 152 is similar to the electro-mechanical speed switch 52 of FIGS. 1-15; therefore, like structure will be identified by like reference number plus “100.” Differences between the electro-mechanical speed switch 152 of FIG. 16 and electro-mechanical speed switch of FIGS. 1-15 will be discussed below.

The electro-mechanical speed switch 152 includes a cam plate 156 and a shaft 170. The shaft 170 is formed with a T-shaped end 202 configured to cooperate with the cam plate 156 to permit axial displacement of the shaft 170 within the housing 14. In comparison to the shaft 70, the T-shaped end 202 of the shaft 170 of FIG. 16 provides a larger contact area between the shaft 170 and the cam plate 156 at different positions of the shaft 170 when the cam plate 156 is being rotated by the actuator knob (not shown).

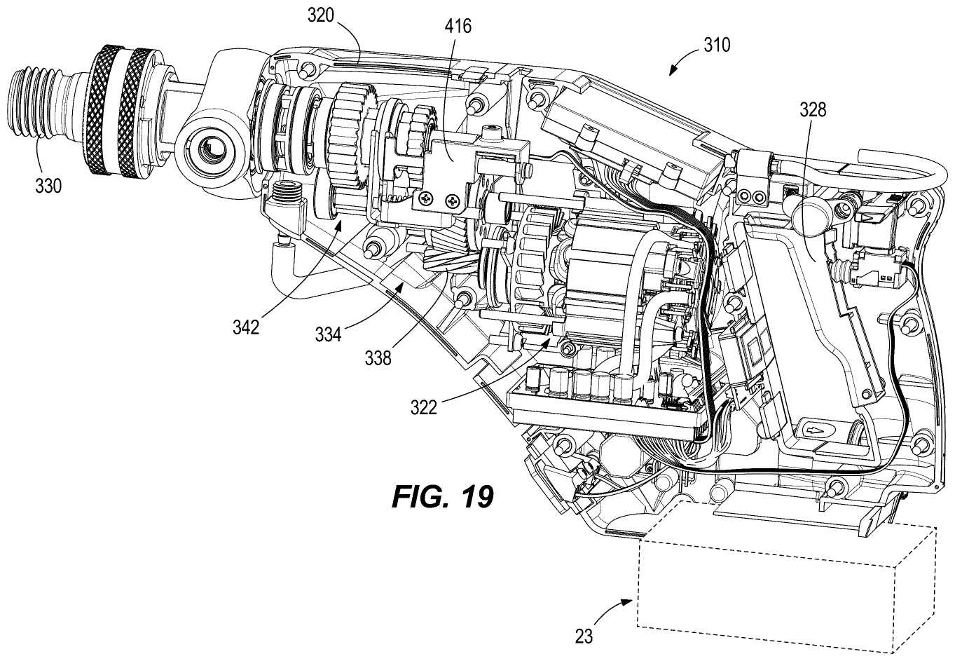

FIGS. 19-23 illustrates another embodiment of a core drill 310. The core drill 310 is similar to the core drill 10 of FIGS. 1-15; therefore, like structure will be identified by like reference number plus “300.” Differences between the core drill 310 of FIGS. 19-23 and core drill 10 of FIGS. 1-15 will be discussed below; however, it should be understood that features and elements of the core drill 10 may be incorporated into the core drill 310 and vise-versa.

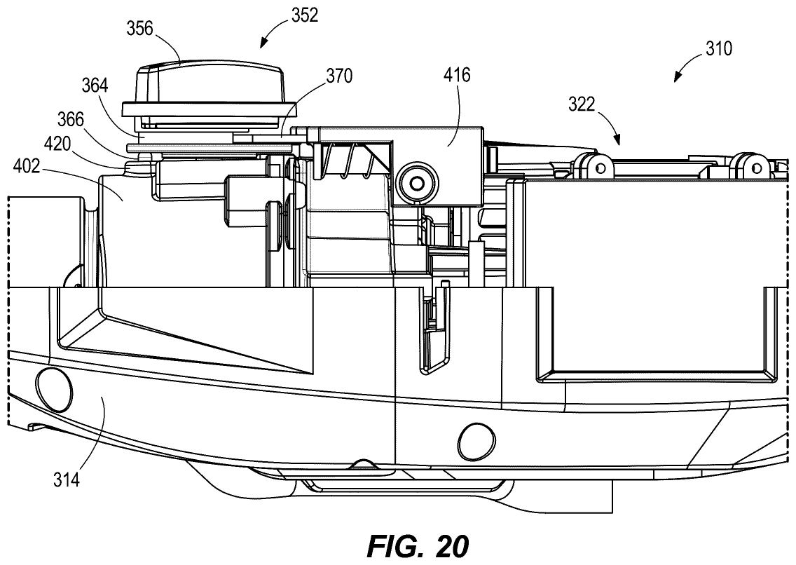

With reference to FIGS. 19 and 20, the core drill 310 includes a housing 314, a portion of which is shown in FIGS. 20-23. The housing 314 is made of a first material, such as a plastic or composite material, and may be defined by cooperating clamshell housing halves. The illustrated housing 314 has a motor housing portion (surrounding a motor 322 of the core drill 310) and a drive housing portion 320 (surrounding a drive assembly 334 of the core drill 310). The drive assembly 334 is configured to transmit torque from an output shaft 338 of the motor 322 to a spindle 330. A tool bit (such as a coring bit; not shown) can be coupled to the spindle 330 for co-rotation with the spindle 330 to perform work (e.g., drilling) on a workpiece. The drive assembly 334 includes a multi-speed transmission 342 that may be similar to the transmission 42 described above with reference to FIGS. 1-15. The multi-speed transmission 342 is disposed within a gear housing 402, which in turn is supported within the drive housing portion 320 of the housing 314. In the illustrated embodiment, the gear housing 402 is made of a second material (e.g., a metal such as steel, aluminum, magnesium, etc.) different from the first material of the housing 314.

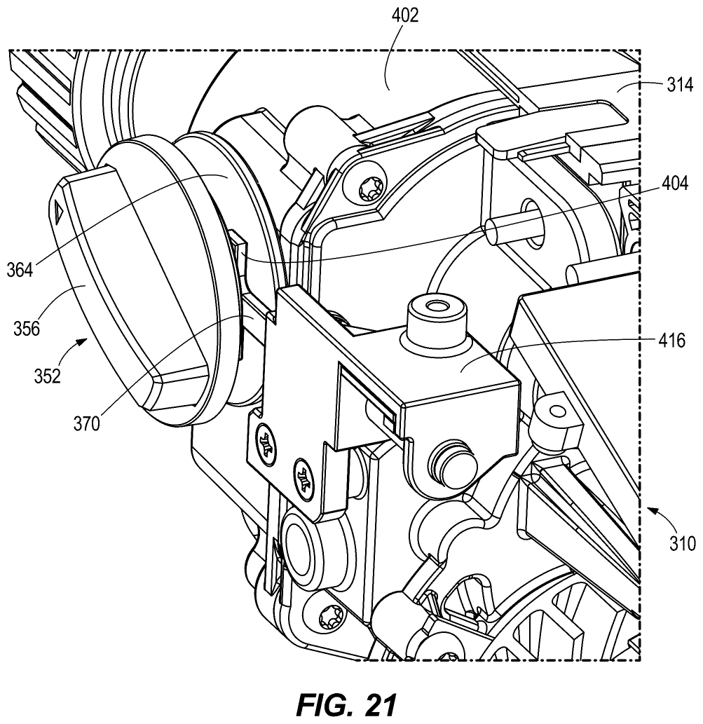

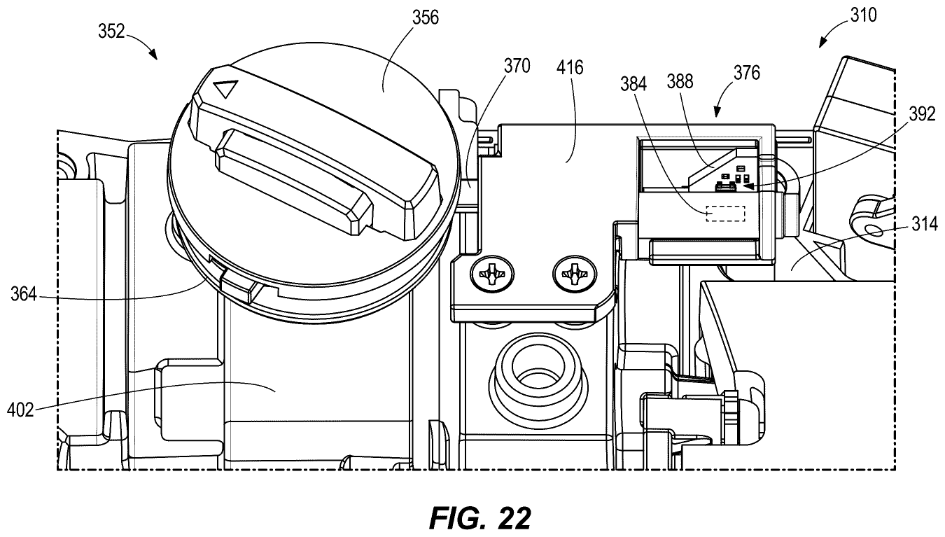

With reference to FIGS. 21 and 22, the illustrated core drill 310 further includes an electro-mechanical speed switch 352, a shaft 370, and a sensing assembly 376. The speed switch 352 has an actuator knob 356 and a cam plate 364 coupled to the actuator knob 356 for co-rotation therewith. The actuator knob 356 is configured to be rotated by a user to adjust an output speed at which the spindle 330 rotates. The cam plate 364, the shaft 370, and the sensing assembly 376 are arranged external of the gear housing 402, and thereby disposed between the gear housing 402 and the housing 314. In other embodiments, the location of the speed switch 352, the shaft 370, and the sensing assembly 376 along the housing 314 of the core drill 310 may vary.

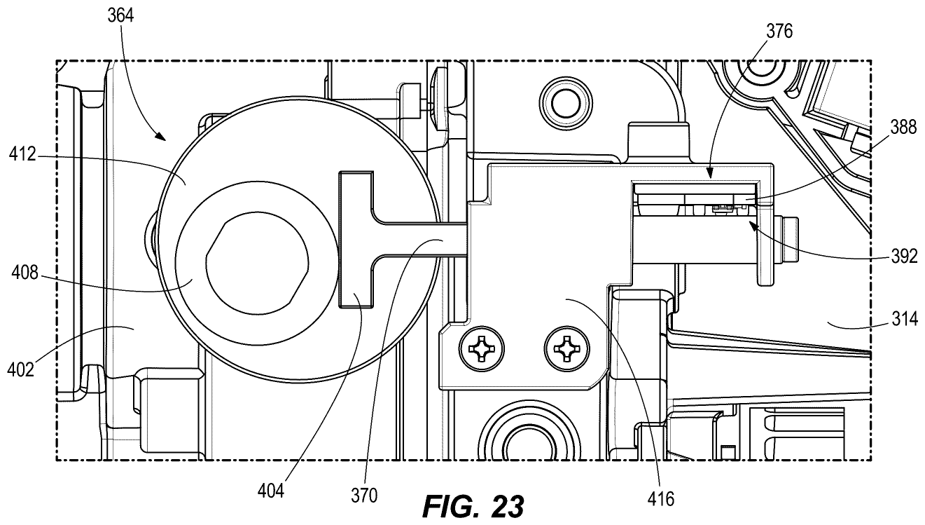

With reference to FIG. 23, the shaft 370 is formed with a T-shaped end 404 configured to cooperate with the cam plate 364 to permit axial displacement of the shaft 370 in response to rotation of the cam plate 364. More specifically, the T-shaped end 404 engages a circular projection 408 extending eccentrically from a plate portion 412 of the cam plate 364. A pocket (not shown) is defined within the shaft 370 and is configured to support and retain a magnet 384 (FIG. 22). The sensing assembly 376 includes a hall sensor board 388 and a Hall Effect sensor 392. The hall sensor board 388 is mounted on a bracket 416 that is fixed to the gear housing 402. The Hall Effect sensor 392 is disposed on the hall sensor board 388. In other embodiments, the Hall Effect sensor 392 may be remote and wired to another separate printed circuit board (PCB). The Hall Effect sensor 392 is configured to detect a position of the magnet 384 as the shaft 370 moves within the housing 314.

The cam plate 364 is configured to co-rotate with the actuator knob 356. When the actuator knob 356 is rotated, the cam plate 364 also rotates such that the shaft 370 is displaced to move the magnet 384. Movement of the magnet 384 is detected via variance in an output signal of the Hall Effect sensor 392, and a controller of the core drill 310 is configured to deliver different voltage and/or current levels to the motor 322 (including but not limited to PWM signals with different duty cycles, etc.) to electrically change speed of the motor 322 without needing to change the gear ratio of the transmission. In the illustrated embodiment, rotation of the actuator knob 356 is also configured to adjust a gear ratio of the transmission 342, in a manner similar to that described above with respect to the core drill 10 of FIGS. 1-15.

During rotation of the cam plate 364, a spring biased pin 366 (FIG. 20) also interacts with the cam plate 364. More specifically, the spring biased pin 366 interacts with one of a plurality of detent pockets (not shown) defined within the cam plate 364. The plurality of detent pockets defines different switch positions corresponding to different output speeds at which the core drill 310 may be operated at. In the illustrated embodiment, the spring biased pin 366 extends from a projection 420 formed on the gear housing 402. In other embodiments, the spring biased pin 366 may extend from the actuator knob 356.

Although the disclosure has been described in detail with reference to certain preferred embodiments, variations and modifications exist within the scope and spirit of one or more independent aspects of the disclosure as described.

Various features and aspects of the disclosure are set forth in the following claims.

What is claimed is:

1. A power tool comprising:
a housing;
a motor supported within the housing;
a transmission operatively coupled to the motor, the transmission shiftable between a low speed high torque mode and a high speed low torque mode;
a spindle configured to receive torque from the motor through the transmission;
a speed selector including an actuator movable to shift the transmission between the low speed high torque mode and the high speed low torque mode, a shaft movable in response to movement of the actuator, and a magnet coupled to the shaft; and
a controller configured to vary an operating speed of the motor based on a detected position of the magnet.

2. The power tool of claim 1, wherein the speed selector further includes a cam plate coupled to and movable by the actuator, and wherein the shaft is configured to be axially displaced by movement of the cam plate to vary the operating speed of the motor.

3. The power tool of claim 2, wherein the shaft has a pocket configured to retain the magnet.

4. The power tool of claim 2, wherein the shaft is formed with a tapered end engaged with the cam plate.

5. The power tool of claim 2, wherein the shaft is formed with a T-shaped end engaged with the cam plate.

6. The power tool of claim 1, wherein the actuator is movable between a first position, a second position, a third position, and a fourth position, each corresponding with a different maximum rotational speed of the spindle.

7. The power tool of claim 6, wherein the transmission is in the low speed high torque mode when the actuator is in the first position and the second position, and wherein the transmission is shifted to the high speed low torque mode when the actuator is in the third position and the fourth position.

8. The power tool of claim 1, wherein the transmission has a shift collar movable by the speed selector to engage a first gear or a second gear to shift between the low speed high torque mode and the high speed low torque mode.

9. A power tool comprising:
a housing;
a motor supported within the housing;
a gear housing supported within the housing;
a transmission disposed within the gear housing and operatively coupled to the motor, the transmission shiftable between a low speed high torque mode and a high speed low torque mode;
a spindle configured to receive torque from the motor through the transmission;
an actuator movable to shift the transmission between the low speed high torque mode and the high speed low torque mode;
a cam coupled to and movable with the actuator;
a shaft configured to be axially displaced by movement of the cam; and
a controller configured to vary an operating speed of the motor in response to displacement of the shaft,
wherein the cam and the shaft are disposed between the housing and the gear housing.

10. The power tool of claim 9, further comprising a sensing assembly disposed between the housing and the gear housing, the sensing assembly configured to detect a position of a magnet supported by the shaft.

11. The power tool of claim 10, wherein the sensing assembly includes a Hall Effect sensor configured to output a signal to the controller.

12. The power tool of claim 9, wherein the housing is defined by cooperating clamshell halves.

13. The power tool of claim 9, wherein the housing is made of a first material, and wherein the gear housing is made of a second material different than the first material.

14. The power tool of claim 13, wherein the first material is plastic and the second material is metal.

15. A power tool comprising:
a housing;
a motor supported within the housing;
a transmission operatively coupled to the motor, the transmission including a first gear, a second gear, and a shift collar configured to engage the first gear or the second gear;
a spindle configured to receive torque from the motor through the transmission;
an actuator rotatable to move the shift collar to engage the first gear or the second gear;
a shaft configured to be axially displaced by rotation of the actuator; and
a sensing assembly configured to detect a position of a magnet supported by the shaft to electronically change an operating speed of the motor.

16. The power tool of claim 15, wherein the sensing assembly includes a sensor board and a Hall Effect sensor disposed on the sensor board, the Hall Effect sensor configured to detect the position of the magnet.

17. The power tool of claim 15, wherein the actuator is rotatable to a first position in which the shift collar is moved to engage the first gear such that the operating speed of the motor is a first operating speed.

18. The power tool of claim 17, wherein the actuator is rotatable to a second position in which the shift collar remains engaged to the first gear and the shaft is axially displaced to thereby move the magnet in a first direction such that the operating speed of the motor is a second operating speed.

19. The power tool of claim 18, wherein the actuator is rotatable to a third position in which the shift collar is moved to engage the second gear and the shaft is axially displaced to thereby move the magnet further in the first direction such that the operating speed of the motor is a third operating speed.

20. The power tool of claim 19, wherein the actuator is rotatable to a fourth position in which the shift collar remains engaged to the second gear and the shaft is axially displaced to thereby move the magnet in a second direction such that the operating speed of the motor is a fourth operating speed.
